(19) United States
(12) Patent Application Publication
(10) Pub. No.: US 2014/0075164 A1
(43) Pub. Date: Mar. 13, 2014

(54) TEMPORAL LOCALITY AWARE INSTRUCTION SAMPLING

(71) Applicants: Venkat R. Indukuru, Austin, TX (US); Alexander E. Mericas, Austin, TX (US)

(72) Inventors: Venkat R. Indukuru, Austin, TX (US); Alexander E. Mericas, Austin, TX (US)

(73) Assignee: INTERNATIONAL BUSINESS MACHINES CORPORATION, Armonk, NY (US)

(21) Appl. No.: 13/610,958

(22) Filed: Sep. 12, 2012

(51) Int. Cl. G06F 9/30; G06F 11/30

(52) U.S. Cl. 712/227; 712/E09.016

(57) ABSTRACT

A method and system are disclosed for sampling instructions executing on a computer processor. A computer processor determines a number of times a specified event has occurred within a specified temporal window. The computer processor determines to mark an instruction to be executed for monitoring based on the number of times the specified event has occurred within the temporal window, and in response, the computer processor marks the instruction.

### FIELD OF THE INVENTION

The present invention relates generally to the field of computer processors, and more particularly to instruction sampling within a processor.

### BACKGROUND OF THE INVENTION

Advanced processors typically provide facilities to enable the processor to count occurrences of software-selectable events and to time the execution of processes within an associated data processing system. These facilities may be referred to as performance monitors. Performance monitoring provides the ability to optimize software that is to be used by the system. A performance monitor may comprise any facility that is incorporated into the processor and is capable of monitoring selectable characteristics of the processors. A performance monitor may produce information related to the utilization of a processor's instruction execution and storage control. The performance monitor can provide information, for example, regarding the amount of time that has passed between events in a processing system. A software engineer may use the timing data gathered with the performance monitor to optimize programs by relocating branch instructions and memory accesses, for example. A performance monitor may also be used to gather data about the access times to the data processing system's L1 cache, L2 cache, and main memory. Using this data, system designers may identify performance bottlenecks specific to particular software or hardware environments. The information generated by performance monitors usually guides system designers toward ways of enhancing performance of a given system or of developing improvements in the design of a new system.

A performance monitor typically includes at least one register that is configured to count the occurrence of one or more specified events. A programmable control register may permit a user to select the events within the system to be monitored and may specify the conditions under which the counters are enabled. It is often considered unnecessary and highly impractical to monitor every instruction that is executed by a processor due to the extremely large number of instructions that are executed in a short period of time. Instead, performance monitoring is typically enabled for only a sample of instructions. Detailed information about the sample instructions is collected as the instructions execute. Instructions for sampling may be randomly selected or may be based upon a deterministic variable such as the instruction's location within an internal queue of the processor.

### SUMMARY

Embodiments of the present invention disclose a method and system for sampling instructions executing in a computer processor. A computer processor determines a number of times a specified event has occurred within a specified temporal window. The computer processor determines to mark an instruction to be executed for monitoring based on the number of times the specified event has occurred within the temporal window. The computer processor marks the instruction.

### BRIEF DESCRIPTION OF THE SEVERAL VIEWS OF THE DRAWINGS

FIG. 1 is a functional block diagram illustrating a data processing system, in accordance with an embodiment of the present invention.

FIG. 2 is a flowchart depicting general operational steps of sampling logic for determining if and when to mark an instruction for detailed performance monitoring, in accordance with an embodiment of the present invention.

FIG. 3 depicts an exemplary process flow of one implementation of the sampling logic depicted in FIG. 2.

### DETAILED DESCRIPTION

As will be appreciated by one skilled in the art, aspects of the present invention may be embodied as a method or system. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

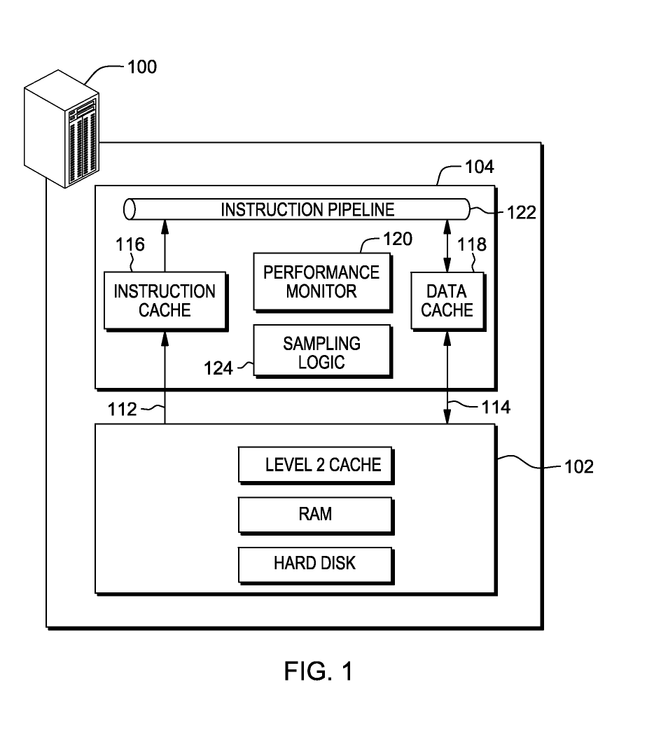

The present invention will now be described in detail with reference to the Figures. FIG. 1 is a block diagram illustrating a data processing system, generally designated 100, in accordance with one embodiment of the present invention. Data processing system 100 comprises memory 102 and processor 104. As depicted, memory 102 is a hierarchical memory comprising Level 2 cache 106, random access memory (RAM) 108, and hard disk 110. Level 2 cache 106 provides a fast-access cache to data and instructions that can be stored in RAM 108. RAM 108 provides main memory storage for data and instructions and may also provide a cache for data and instructions stored on non-volatile hard disk 110.

Data and instructions may be transferred to processor 104 from memory 102 on instruction transfer path 112 and data transfer path 114. Transfer paths 112 and 114 may be implemented as a single bus or as separate buses between processor 104 and memory 102. Alternatively, a single bus may transfer data and instructions between processor 104 and memory 102 while processor 104 provides separate instruction and data transfer paths within processor 104.

Processor 104 also comprises instruction cache 116, data cache 118, performance monitor 120, and instruction pipeline 122. In one embodiment, processor 104 may be a pipelined processor capable of executing multiple instructions in a single cycle. During operation of data processing system 100, instructions and data are stored in memory 102. Instructions to be executed are transferred to instruction pipeline 122 via instruction cache 116. Instruction pipeline 122 decodes and executes the instructions that have been staged within the pipeline. Some instructions transfer data to or from memory 102 via data cache 118. Other instructions may operate on data loaded from memory or may control the flow of instructions.

Performance monitor 120 comprises one or more registers and counters and control logic to detect, monitor, and/or analyze events corresponding to executing instructions. More specifically, performance monitor 120 monitors the entire system and accumulates counts of events that occur as the result of processing instructions. Processor 104 may also employ speculative execution to predict the outcome of conditional branches of certain instructions before the data on which the certain instructions depend is available. When the performance monitor is used in conjunction with speculatively executed instructions, the performance monitor may be used as a mechanism to monitor the performance of processor 104 during execution of both completed instructions and speculatively executed yet uncompleted instructions. Of course, depending on the data instruction being executed, “complete” may have different meanings. For example, for a “load” instruction, “complete” indicates that the data associated with the instruction was received, while for a “store” instruction, “complete” indicates that the data was successfully written.

As instructions are executed, they cause events within processor 104, such as cache accesses, cache misses, floating point operations, etc. Performance monitor 120 contains counters that count events under control of a control register. The counters and control registers are internal processor registers and can be read or written under software control. At least one counter is required to capture data for some type of performance analysis. More counters may provide faster or more accurate analysis.

Processor 104 also includes sampling logic 124. As previously discussed, it would be inefficient to monitor every instruction being executed, and as such, only a sample of all instructions are chosen for collecting detailed information on that instruction. Previous techniques for selecting this sample include selecting instructions randomly, selecting instructions based on general category of instruction type, and selecting instructions based on instruction address. The selected instruction is marked, and as the instruction flows through the pipeline, the instruction, and events caused by the instruction, can be monitored. However, when trying to analyze a certain type of event that is of importance to a system designer, collecting data from instructions selected under such techniques may not provide the most relevant information. Sampling logic 124 provides a mechanism to mark instructions for detailed monitoring only when the temporal locality of a specified event (i.e., the specified event occurs at a relatively high frequency over a small duration of time) is high enough to warrant a sample. For example, for performance improvement, it may be more useful to sample instructions only when CPI (cycles per instruction) is temporally high. When CPI is low, the processor is completing instructions efficiently and monitoring such instructions might be uninteresting (or at least less interesting) for performance improvement. Sampling logic 124 can search for any event detectable by processor 104 over a specified durational or temporal window. Detectable events include, in a non-exhaustive list, completed instructions, stalls, cache accesses, cache misses, branch mispredicts, floating point operations, etc. A temporal window can be any duration measurable to processor 104, including a specified number of cycles, a specified number of other detectable events (stalls, etc.), or, of course, time. If, at the end of the temporal window, a specified event has been detected greater than a threshold number of times, sampling logic 124 may cause the next available instruction to be marked.

As used herein, “logic” such as control logic and sampling logic, is a sequence of steps required to perform a specific function, and, in the preferred embodiment, is implemented through firmware, such as low-level program instructions stored on a read only memory (ROM) and executed by one or more control circuits or, alternatively, hardwired computer circuits and other hardware.

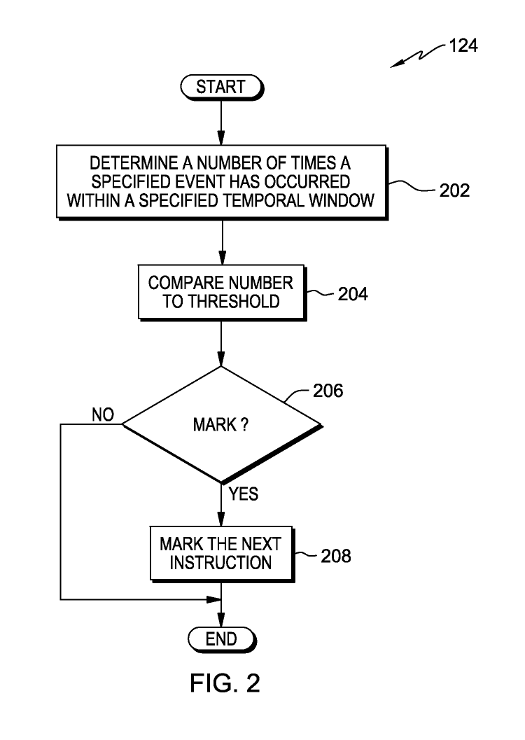

FIG. 2 depicts general operational steps of sampling logic 124 for determining which instructions to mark for performance monitoring, in accordance with one embodiment of the present invention.

Sampling logic 124 determines a number of times a specified event has occurred within a specified temporal window (step 202). This can be done in a variety of ways, including keeping an active count of occurrences of the specified event (e.g., cache misses, completed instructions, etc.) over a tracked duration (e.g., number seconds, number of cycles, etc.). The number is compared to a threshold (step 204) and sampling logic 124 determines, from this comparison, whether to mark the next available instruction (decision 206). Depending on the specified events being counted, sampling logic 124 may determine to mark the instruction if the number meets or exceeds the threshold, or alternatively may determine to mark the instruction only if the threshold is not reached. If sampling logic determines to mark the instruction, the next available instruction is marked for performance monitoring (step 208).

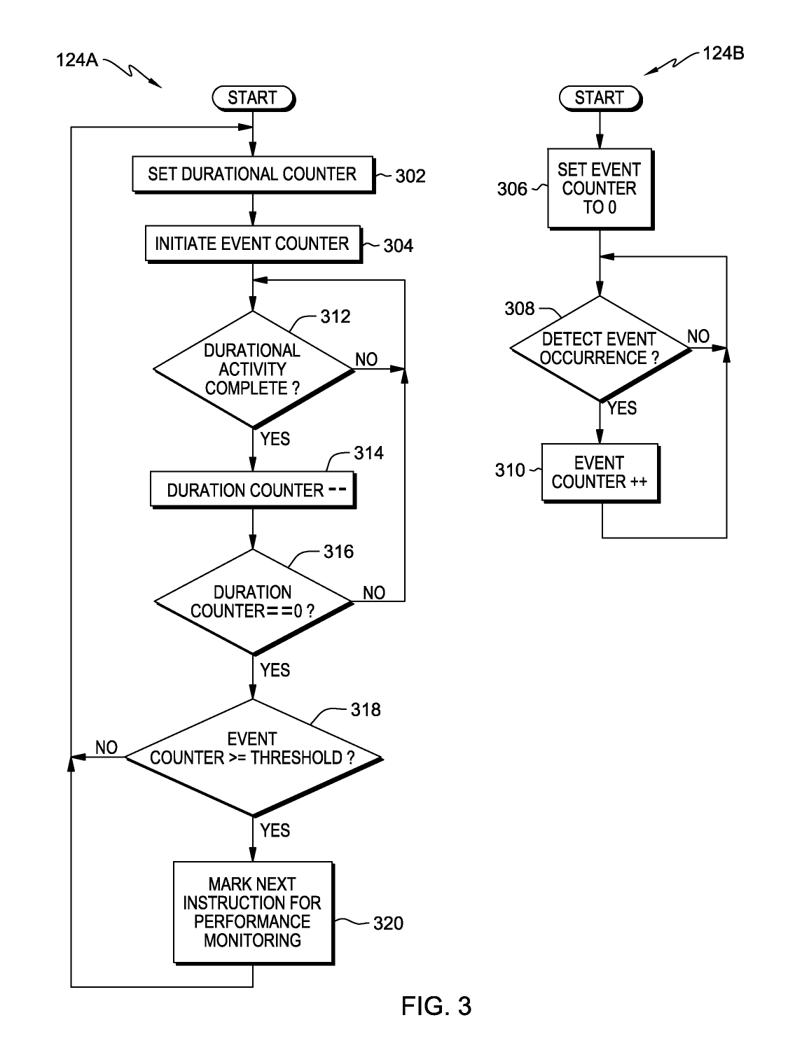

FIG. 3 depicts a detailed exemplary implementation of sampling logic 124 according to an illustrative embodiment of the present invention. As depicted, sampling logic 124 is broken into a marking routine 124A and an event counter subroutine 124B.

Marking routine 124A sets a durational activity counter (step 302) representing the temporal window to be analyzed. For example, if a system designer wants to measure CPI over ten thousand cycles, the durational activity counter may be set to 10,000. The durational activity counter is decremented as durational activities are completed. Any activity detectable by processor 104 may be used to define the temporal window. In another embodiment, the durational activity counter may be set to 0 and incremented as durational activities are completed. In such an embodiment, after every addition, the durational activity counter is compared to a durational threshold representative of the desired temporal window (e.g., 10,000 cycles).

Marking routine 124A also initiates an event counter (step 304), depicted here as event counter subroutine 124B. Event counter subroutine 124B sets an event counter to 0 (step 306) and if an occurrence of a specified event is detected (yes branch, decision 308), increments the event counter (step 310). In a preferred embodiment, event counter subroutine 124B runs concurrently with marking routine 124A.

As discussed previously, the event counted can be any event detectable by processor 104 and specified by a user or system designer. For example, the specified event could be completed instructions. Other examples include cache accesses, cache misses, branch mispredicts, floating point operations, and stalls.

After the durational counter has been set and the event counter has been initialized, marking routine 124A determines whether a durational activity has been completed (decision 312). Every time that marking routine 124A detects that a durational activity has been completed (yes branch, decision 312), the durational activity counter is decremented (step 314). Marking routine 124A subsequently determines whether the durational activity counter has reached 0 (decision 316), indicating that the temporal window has completed.

If the durational activity counter has not reached zero (no branch, decision 316), marking routine 124A continues to monitor durational activities and decrement the counter when necessary. If the durational activity counter has reached zero (yes branch, decision 316), marking routine 124A determines whether the event counter has met or exceeded a defined threshold number of occurrences of the specified event (decision 318). If the event counter is less than the threshold (no branch, decision 318), then the counters are reset and the tracking begins again. If the event counter does meet or exceed the threshold (yes branch, decision 318), the next available instruction is marked for performance monitoring (step 320).

In an alternate embodiment, the threshold number might represent a lower threshold and an instruction can be marked for monitoring only if the event counter is less than the threshold number. For example, a system designer may determine that it would be beneficial to monitor instructions when there are a relatively high number of cache misses in a given period. In such an instance, if the number cache misses in a given number of cycles exceeded a threshold number, an instruction could be marked. However, if a system designer wants to monitor instructions when CPI is relatively high for a given period, completed instructions can be monitored. The higher the number of completed instructions during a given number of cycles, the lower the average CPI for that duration of cycles (if 10,000 instructions are counted in a durational window of 10,000 cycles, then the average CPI during the period is 1/1). The lower the number of completed instructions, the higher the average CPI for the duration of cycles (if 1,000 instructions are counted in a durational period of 10,000 cycles, then the average CPI during the period is 10/1). Hence, in such an embodiment, if the counted instructions are less than a threshold number of instructions, marking routine 124A marks an instruction.

In another embodiment, the threshold may be a rate that should or should not be exceeded. Instead of using the event counter as a direct comparison to a threshold number, the event counter is used in combination with a durational threshold to determine an average rate for the duration, and the average rate is analyzed against the threshold rate. For example, instead of comparing a counted number of completed instructions to a threshold number of instructions, average cycles per instruction can be calculated based on the number of instructions completed over the duration of cycles, and the average cycles per instruction can be compared to a threshold cycles per instruction. Similarly, read or write bytes per cycle (or some other memory bandwidth representation) can be calculated and compared to a threshold memory bandwidth.

A person of ordinary skill in the art will also understand that determination of duration may occur in a number of ways. As previously mentioned, instead of a decrementing counter, a counter may be incremented and compared to a durational threshold. In another embodiment, sampling logic 124 may simply monitor an internal clock. Similarly, the event counter may instead be decremented from a threshold number each time a specified event is detected. If, at the time the temporal window has completed, the event count has reached 0, then the threshold has been reached and an instruction can be marked.

In another embodiment, sampling logic 124 need not wait for the temporal window to complete prior to determining if the event counter has surpassed a threshold. For example, in the previously described implementation, if the durational counter is set high, the event counter may surpass the threshold relatively early in the temporal window; and instead of monitoring instructions of interest, no instructions are marked until the durational count is complete. In an embodiment that does not need to wait for the temporal window to complete, the event count can be compared to the threshold after every increment, or alternatively can be compared to the threshold at smaller intervals within the temporal window.

The routines and logic described herein are identified based upon the function for which they are implemented in a specific embodiment of the invention. However, it should be appreciated that any particular nomenclature herein is used merely for convenience, and thus the invention should not be limited to use solely in any specific function identified and/or implied by such nomenclature.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for sampling instructions executing in a processor, the method comprising:
determining a number of times a specified event has occurred within a specified temporal window;
determining to mark an instruction to be executed for monitoring based on the number of times the specified event has occurred within the temporal window; and
marking the instruction.

2. The method of claim 1, wherein said determining to mark the instruction to be executed for monitoring based on the number of times the specified event has occurred within the temporal window, comprises determining to mark the instruction to be executed for monitoring based on the number of times the specified event has occurred within the temporal window as compared to a specified threshold value.

3. The method of claim 2, wherein said determining to mark the instruction to be executed for monitoring based on the number of times the specified event has occurred within the temporal window as compared to the specified threshold value, comprises determining to mark the instruction to be executed for monitoring if the number of times the specified event has occurred meets or exceeds the specified threshold value.

4. The method of claim 2, wherein said determining to mark the instruction to be executed for monitoring based on the number of times the specified event has occurred within the temporal window as compared to the specified threshold value, comprises determining to mark the instruction to be executed for monitoring if the number of times the specified event has occurred does not meet or exceed the specified threshold value.

5. The method of claim 1, wherein said determining to mark the instruction to be executed for monitoring based on the number of times the specified event has occurred within the temporal window, comprises:
determining an average rate of a specified activity within the temporal window, based on the number of times the specified event has occurred within the temporal window; and
comparing the average rate to a threshold rate to determine whether to mark the instruction.

6. The method of claim 5, wherein the average rate of the specified activity and the threshold rate are measured by one of the following: cycles per instruction, memory bandwidth, or the specified event as compared to the temporal window.

7. The method of claim 1, wherein the temporal window is defined by a specified number of times an event detectable by a processor has occurred.

8. The method of claim 1, wherein the specified event is selected from the group consisting of: completed instructions, memory accesses, cache hits, cache misses, stalls, floating point operations, and branch mispredicts.

9. The method of claim 1, wherein said determining the number of times the specified event has occurred within the specified temporal window, comprises:
counting occurrences of an event detectable by a processor until the occurrences of the event detectable by the processor meet a durational threshold, the durational threshold being representative of the temporal window; and
counting occurrences of the specified event while the durational threshold is not met.

10. The method of claim 1, wherein said determining to mark the instruction to be executed for monitoring comprises marking a first available instruction to be executed subsequent to a closing of the temporal window.

11. A computer processor comprising:
at least one register;
an instruction cache; and
control logic, which when implemented:
determines a number of times a specified event has occurred within a specified temporal window;
determines to mark an instruction, from the instruction cache, for monitoring based on the number of times the specified event has occurred within the temporal window; and
marks the instruction.

12. The computer processor of claim 11, wherein the control logic to determine to mark the instruction for monitoring based on the number of times the specified event has occurred within the temporal window, comprises control logic, which when implemented, determines to mark the instruction for monitoring based on the number of times the specified event has occurred within the temporal window as compared to a specified threshold value.

13. The computer processor of claim 12, wherein the control logic to determine to mark the instruction for monitoring based on the number of times the specified event has occurred within the temporal window as compared to the specified threshold value, comprises control logic, which when implemented, determines to mark the instruction for monitoring if the number of times the specified event has occurred meets or exceeds the specified threshold value.

14. The computer processor of claim 12, wherein the control logic to determine to mark the instruction for monitoring based on the number of times the specified event has occurred within the temporal window as compared to the specified threshold value, comprises control logic, which when implemented, determines to mark the instruction for monitoring if the number of times the specified event has occurred does not meet or exceed the specified threshold value.

15. The computer processor of claim 11, wherein the control logic to determine to mark the instruction for monitoring based on the number of times the specified event has occurred within the temporal window, comprises control logic, which when implemented:
determines an average rate of a specified activity within the temporal window, based on the number of times the specified event has occurred within the temporal window; and
compares the average rate to a threshold rate to determine whether to mark the instruction.

16. The computer processor of claim 15, wherein the average rate of the specified activity and the threshold rate are measured by one of the following: cycles per instruction, memory bandwidth, or the number of times the specified event has occurred as compared to the temporal window.

17. The computer processor of claim 11, wherein the temporal window is defined by a specified number of times an event detectable by a processor has occurred.

18. The computer processor of claim 11, wherein the specified event is selected from the group consisting of: completed instructions, memory accesses, cache hits, cache misses, stalls, floating point operations, and branch mispredicts.

19. The computer processor of claim 11, wherein the control logic to determine the number of times the specified event has occurred within the specified temporal window, comprises control logic, which when implemented:
counts occurrences of an event detectable by the computer processor until the occurrences of the event detectable by the computer processor meet a durational threshold, the durational threshold being representative of the temporal window; and
counts occurrences of the specified event while the durational threshold is not met.

20. The computer processor of claim 11, wherein the control logic to determine to mark the instruction for monitoring comprises control logic, which when implemented, marks a first available instruction to be executed subsequent to a closing of the temporal window.
